(19) United States
(12) Patent Application Publication
(10) Pub. No.: US 2026/0227843 A1
(43) Pub. Date: Aug. 6, 2026

(54) USING A VOLTAGE CONTROL LOOP TO MODIFY VOLTAGES IN A PROCESSING UNIT

(71) Applicant: INTERNATIONAL BUSINESS MACHINES CORPORATION, ARMONK, NY (US)

(72) Inventors: Pradeep Bhadravati Parashurama, Bhadravati (IN); Tobias Webel, Schwaebisch-Gmuend (DE); Phillip John Restle, Katonah, NY (US); Alper Buyuktosunoglu, White Plains, NY (US); Ramon Bertran Monfort, New Orleans, LA (US); Aishwarya Rajiv Tadkase, Bangalore (IN); Alejandro Alberto Cook Lobo, Renningen (DE); Sean Michael Carey, Dutchess, NY (US); KARL EVAN SMOCK ANDERSON, Poughkeepsie, NY (US); Michael ROMAIN, Long Island City, NY (US); Kevin P. Low, Poughkeepsie, NY (US); Rahman Abber Tahir, Herrenberg (DE)

(21) Appl. No.: 19/046,843

(22) Filed: Feb. 6, 2025

(51) Int. Cl. G06F 1/3296; G06F 1/3206

(52) U.S. Cl. CPC G06F 1/3296; G06F 1/3206

(57) ABSTRACT

Provided are a computer implemented method, system, and processor for using a voltage control loop to modify voltages in a processing unit. A performance degradation value for the processing unit is calculated based on instances of a mitigation measure performed when an output value of a sensor satisfies a threshold condition. The performance degradation value is inputted to a function to output a voltage increase. The function provides different voltage increases for different performance degradation values. The voltage supplied to the processing unit is increased by the voltage increase.

### BACKGROUND OF THE INVENTION

### 1. Field of the Invention

The present invention relates to a computer implemented method, system, and processor for using a voltage control loop to modify voltages in a processing unit.

### 2. Description of the Related Art

In distributed computing environments, there can be numerous jobs or queries arriving as workloads to be processed on a processor in the computing environment. A processor core is a processing unit that reads instructions to perform specific actions. Instructions are chained together so that, when run in real-time on the processor, the processor executes the desired workload formed by the instructions. A multicore processor is a computer processor on a single integrated circuit with two or more separate processing units, which are the cores, each of which reads and executes program instructions. The instructions are ordinary instructions (such as add, move data, branch, etc.) but the single processor can run instructions on separate cores at the same time, increasing the overall speed for programs that support multithreading or other parallel computing techniques.

### SUMMARY

Provided are a computer implemented method, system, and processor for using a voltage control loop to modify voltages in a processing unit. A performance degradation value for the processing unit is calculated based on instances of a mitigation measure performed when an output value of a sensor satisfies a threshold condition. The performance degradation value is inputted to a function to output a voltage increase. The function provides different voltage increases for different performance degradation values. The voltage supplied to the processing unit is increased by the voltage increase.

Further provided are a computer implemented method, system, and processor having a timing protection control loops for the cores. A timing protection control loop of the timing protection control loops processes an output value from a sensor to determine whether to implement a mitigation measure to throttle instruction execution at a core. A voltage control loop for a plurality of the cores to calculate a performance degradation value based on instances output values calculated by timing protection loops at the cores satisfied a threshold condition. The performance degradation value is inputted to a function to output a voltage increase. The function provides different voltage increases for different performance degradation values. The voltage supplied to the processor and the cores is increased by the voltage increase.

### BRIEF DESCRIPTION OF THE DRAWINGS

FIG. 1 illustrates an embodiment of a processor including a plurality of cores.

FIG. 2 illustrates an embodiment of a core in the processor.

FIG. 3 illustrates an embodiment of timing control loop operations performed for a core.

FIG. 4 illustrates an embodiment of voltage control loop operations performed for the processor.

FIG. 5 illustrates an embodiment of operations to update a voltage look-up table used by the voltage control loop.

FIG. 6 illustrates a computing environment in which the components of FIGS. 1 and 2 may be implemented.

### DETAILED DESCRIPTION

High transistor counts and dense circuits in a processor results in nanosecond timescale changes in current and a supply voltage droop, i.e., reduction in voltage having significant impacts on performance, when a workload suddenly increases power demand. To preserve timing margin and prevent circuit failure, the input supply voltage must account for the maximum workload induced droop in addition to other guardband components protected by the voltage and timing management at the processor. Droop mitigation techniques to prevent large drops in voltage, also known as droops, that can result in errors include core throttling and rapid frequency reduction that increase number of cycles needed to execute an instruction.

Described embodiments provide improvements to processor guardband techniques to prevent supply voltage droops using timing protection control loops at the cores in a processor to allow rapid throttling of execution of instructions at the cores upon detecting timing margins or voltage margins reaching thresholds indicating performance degradation. The timing protection control loops collect information on the number of times throttling was triggered and the number and fraction of clock cycles throttled. The timing protection control loops operate more frequently than the separate voltage control loop. The separate voltage control loop, that operates substantially less frequently than the timing protection control loops, uses the information collected by the timing protection loops at the cores to determine a performance degradation value. This performance degradation value is then inputted into a function, such as a look-up table, that provides different voltage increases for different performance degradation values exceeding a performance degradation threshold. In this way, the level of voltage increase is different depending on the level of performance degradation detected. Higher levels of performance degradation require larger voltage increases to reduce voltage drooping than lower levels of performance degradation.

Further, described embodiments allow for reduction of voltage if the information collected from the timing protection control loops at the cores indicates that incidences of throttling is at a steady-state low level. Described embodiments provide techniques for preventing large voltage oscillations in the case of very low-noise workloads. Such oscillations can result in excess performance loss and higher average power. These oscillations can occur during low-noise workloads, where a small reduction in voltage can result in a large increase in performance loss and a resulting large increase in voltage, repeatedly. The solution involves detecting this low-noise condition, and using this information to avoid any voltage reductions that would result in large oscillations.

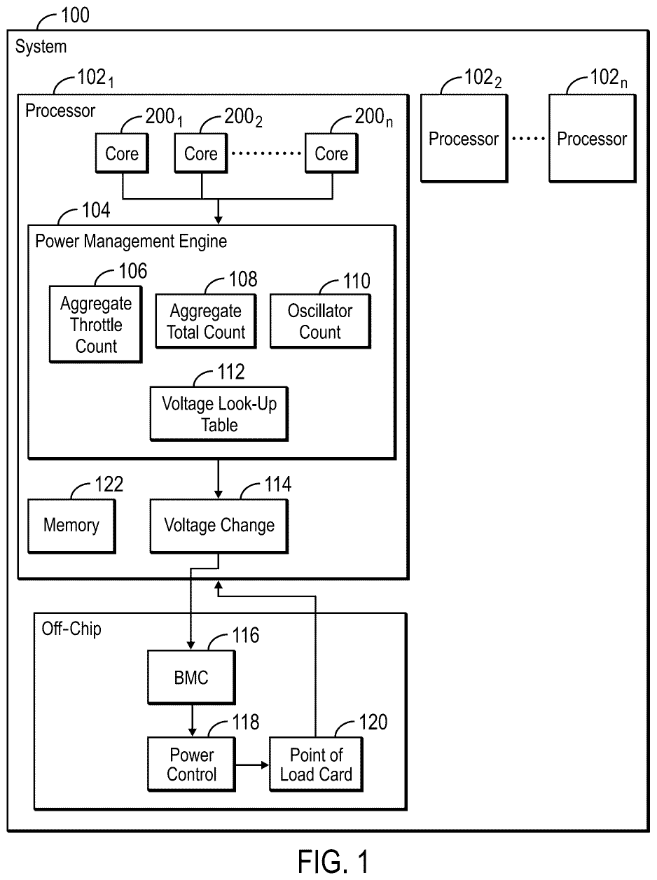

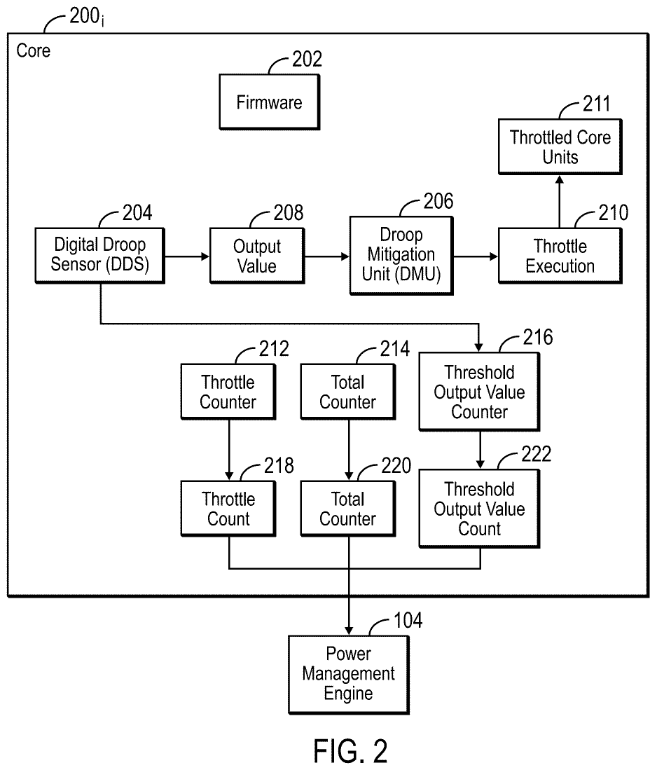

FIG. 1 illustrates an embodiment of a system 100 including a plurality of processors 102₁, 102₂. . . 102ₙ. Each processor 102ᵢ, as shown with respect to processor 102₁, may include one or more processing cores 200₁, 200₂. . . 200ₙ. FIG. 2 illustrates an embodiment of one of the cores 200ᵢ. The core 200ᵢ includes firmware 202 to manage core operations. The core further includes at least one digital droop sensor (DDS) 204 and droop mitigation unit (DMU) 206 implementing a timing protection control loop implemented in hardware. The DDS 204 comprises analog or digital components and detects an operational margin, such as a timing margin or voltage margin, comprising a difference between the actual timing or voltage from a margin threshold value. The DDS may then convert the detected operational margin, such as a timing cycle time, to an output value 208 comprising one of a fixed number of possible output values. The DDS may comprise other types of sensors to measure and sense other types of operation metrics in the core relevant to determining the occurrence of performance degradation and voltage droops.

The DMU 206 may process this output value 208 to determine whether mitigation techniques are needed, such as core execution throttling and rapid frequency reduction to mitigate a droop. The DMU may use firmware to control the voltage. Upon the DMU 206 determining to implement mitigation, the DMU may perform throttle execution 210 to throttle or increase number of cycles to execute an instruction at throttled core units 211, such as an instruction fetch and branch, instruction cache and merge, instruction decode, and instruction sequence. The DMU uses firmware to control the voltage. High throttling rates to reduce rate of program instruction execution raise the voltage by reducing processing burdens. The DDS throttles the core when a DDS output value falls below a throttle output value. One advantage of throttling over other mitigation methods is that the throttling can persist as long as needed until margin increases above the throttling-threshold value.

The DDS 204 may comprise a programmable delay feeding a latch-tapped delay line with a fixed number of possible output values. The DDS output values may be interpreted by the DMU 206 within nanoseconds. In certain embodiments, the DDS is designed using gates and devices common to critical paths in the core. This ensures that the DDS sensitivity to voltage, temperature and accelerated End-Of-Life (EOL) stressing corresponds to that of the core's critical paths. For example, if threshold voltages increase slightly towards EOL, both critical paths and DDS will slow. The voltage control loop will increase voltage slightly at EOL to maintain timing margin and performance.

The DDS 204 may further forward the output value 208 to a throttle counter 212, total counter 214, and threshold value counter 216 to update a throttle count 218, a total count 220, an threshold output value count 222, respectively. If the output value 208 is less than or equal to a throttle output value at which throttling is to occur, then the throttle counter increments the throttle count 218. In this way, the throttle count 218 may track how many cycles are throttled to monitor the performance impact from throttling. The total counter 214 increments the total count indicating a total number of output values 208 that occur in between operations of the voltage control loop. The threshold output value counter 216 increments a threshold output value count 222 indicating a number of times the output values 208 were an output value immediately above the throttle output value, or the first value at which throttling is not to occur. This is a threshold output value at the margin immediately above the output value at which throttling is triggered. The DDS 204 records the counts for use by the voltage control loop to determine whether to increase or decrease a voltage supplied to the processor 102ᵢ including the core 200ᵢ implementing the timing control loop.

The power management engine 104 may read the counts 218, 220, 222, in the different cores at a frequency multiple times the frequency at which the DDS monitors the margin, such as the timing margin. For instance, the DDS 204 may monitor timing margin every cycle. The power management engine 104 may read the counters every 16 ms, which is magnitudes less than the cycles per second in the processor, which may be in the billions. The power management engine 104 uses the read counts to determine whether to modify the voltage supplied to the processor 102ᵢ. The counts 106, 108, 110, 218, 220, 222 may also be referred to as counters.

With respect to FIG. 1, the power management engine 104 may be located on the processor chip external to the cores. The power management engine 104 aggregates the throttle count 218, total count 220, and threshold output value count 222 from the DDSs in the cores into aggregate counts 106, 108, 110, respectively. The counts 106, 108, 110, 218, 220, 222 may also be referred to as counters.

The power management engine 104 may use the aggregate throttle count 106 to determine a performance degradation value indicating an extent to which throttling was triggered by performance degradations in timing or voltage detected by the DDS. The performance degradation value may be inputted into a voltage look-up table 112. The voltage look-up table 112 associates different performance degradation values with different voltage changes. The voltage look-up table outputs a voltage change 114 based on an input performance degradation value. For instance, greater performance degradation values may result in higher voltage increases to improve performance than lower performance degradation values requiring a lessor voltage increase to boost performance. Further, the voltage control loop implemented by the power management engine is asymmetric, increasing voltage more quickly than lowering. If a high rate of throttling is observed in any voltage control loop period, e.g., 16 ms, the voltage is increased a relatively large amount, such as up to 4% in a single request. Voltage decreases may be fixed at a lower increase level, e.g., 0.5% and require low throttling for at least 64 ms before a request is made.

The processor may further include a memory 122 to store data used by the cores from an external storage. Further, the cores may each include L1 and L2 caches to buffer data from the processor memory 122 for immediate use.

In certain embodiments, the power management engine 104 may change the DDS delay and change supply voltage.

In alternative embodiments, instead of using a voltage look-up table 112, the power management engine 104 may input a performance degradation value to a function or program to then calculate the voltage change. The function or program may comprise an algorithm, heuristic rules-based system or machine learning model to determine a voltage change from a performance degradation value. In further embodiments, the function used to output the voltage change may receive as input other information that could affect an optimal voltage change determination, including, but not limited to, factors including a temperature at the processor, whether the processor is in a maintenance mode, whether a current voltage is within a limit whether the modified voltage resulting from the calculated voltage change is within a limit when the current voltage is not within the limit; whether power is within a limit; and whether the power of other system components are within a limit.

The power management engine 104 may forward the voltage change 114 with a command to a baseboard management controller (BMC) 116 to control a processor power controller 118 to produce an adjusted voltage to a point of load card (POL) 120 to provide the precise adjusted voltage to the processor or cores within the processor.

In the embodiment of FIG. 1, the voltage control loop to produce voltage change is applied to the processor and cores therein as a whole. In this way, the same adjusted voltage is supplied to all the cores. In an alternative embodiment, there may be a separate voltage control loop for each core to allow independent adjustment of the voltage supplied to each core. In still further embodiments, there may be multiple voltage control loops, including one voltage control loop for a subset of cores.

In the embodiment of FIG. 1, there is a separate timing protection control loop, comprised of the DDS and DMU, for each core, within the core. In alternative embodiments, one timing protection control loop may perform throttling for multiple cores.

The term processing unit may refer to any type of processing unit, including a processor having cores, one or more of the cores on a processor chip, a chiplet, etc.

The components in the processor and core, including 104, 106, 112, 116, 118, 120, 204, 206, 212, 214, 216 may be implemented as hardware or firmware or a combination thereof.

The arrows shown in FIGS. 1 and 2 illustrate a flow and direction of operations as well as connections between components.

The system 100 may comprise various types of computing devices, including desktop computers, servers, laptops, tablets, smartphones, wearable computers, network devices, inference engines, etc.

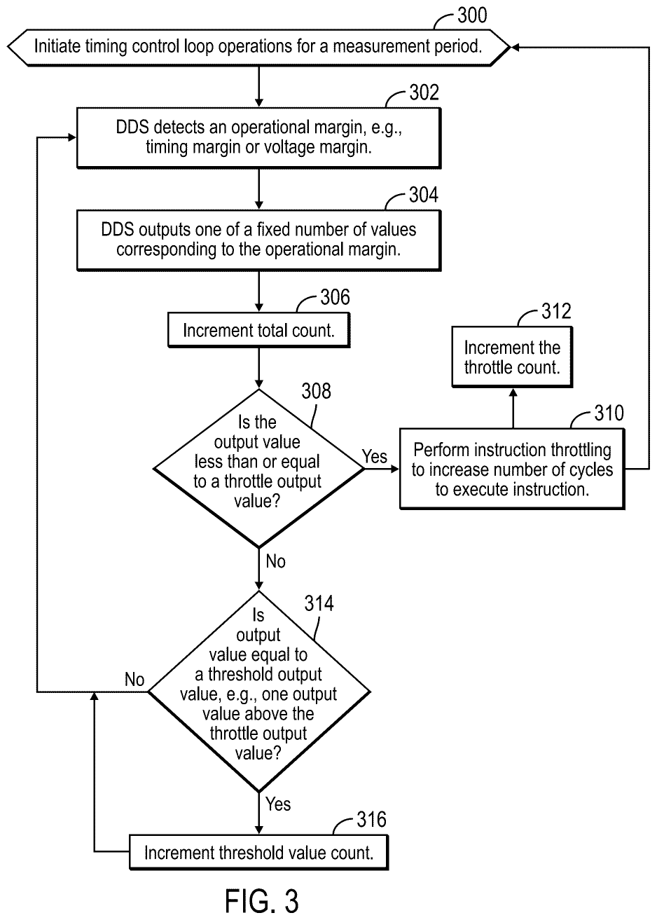

FIG. 3 illustrates an embodiment of operations performed in the timing protection control loop by the DDS, or other type of sensor, and the DMU. In certain embodiments, the sensor and DMU may comprise the DDS 204 and DMU 206 described with respect to FIGS. 1 and 2. Timing protection control loop operations may be performed on every cycle, and there may be billions of cycles per second. Upon initiating (at block 300) timing control loop operations, the DDS, or other type of sensor, detects or infers (at block 302) an operational margin, such as a timing margin or voltage margin. The DDS outputs (at block 304) one of a fixed number of possible values corresponding to the operational margin. The total counter would increment (at block 306) the total count indicating the number of output values produced. If (at block 308) the output value is less than or equal to a throttle output value, then the DMU may initiate (at block 310) throttle execution to increase the number of cycles to execute an instruction. The throttling is performed as part of a droop mitigation technique, such as core throttling and repad frequency reduction. Upon throttling, the throttle counter may increment (at block 312) the throttle count, which indicates a number of cycles during which the cores were not submitting instructions. If (at block 314) the output value is equal to a threshold output value, which may comprise an output value one above the throttle output value, then the threshold output value counter may increment (at block 316) a threshold output value count. From block 316 or the NO branch of block 314, control proceeds back to block 302 to perform another iteration of timing protection control loop operations to determine whether to further throttle instruction execution to avoid voltage droops.

With the embodiment of operations of FIG. 3, timing protection control loop operations are performed to introduce throttling to preserve a timing margin and prevent circuit failure. Further, as part of determining whether to throttle and mitigate based on the DDS output, certain counts may be incremented to gather information for the voltage control loop to determine a performance degradation value and other values used to determine whether to change the voltage.

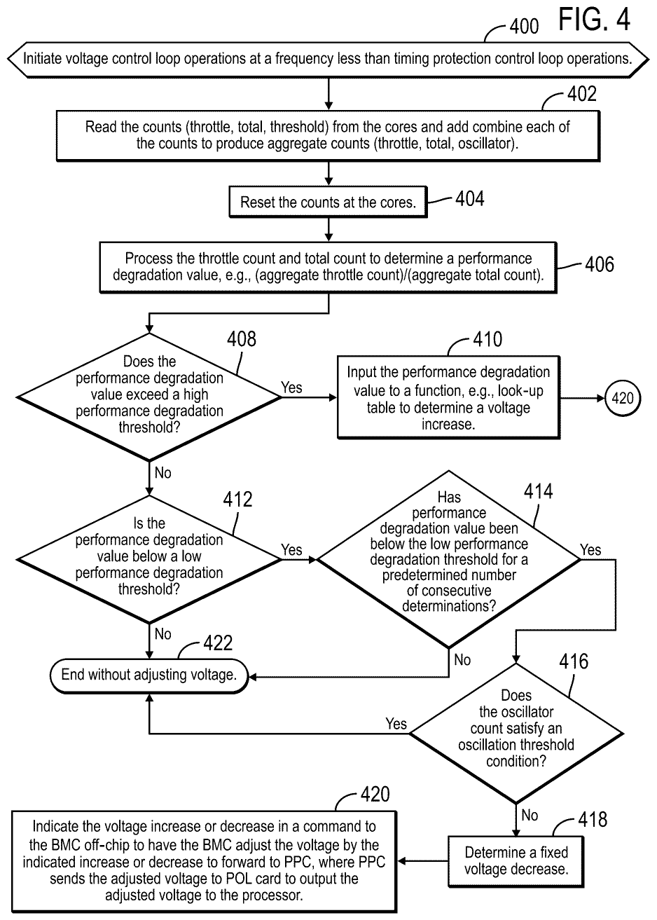

FIG. 4 illustrates an embodiment of voltage control loop operations to periodically determine whether to modify the voltage supplied to the processor and cores therein. Upon initiating (at block 400) a voltage control loop, which occurs after performing numerous timing control loop operations of FIG. 3, the performance management engine reads (at block 402) the counts (throttle, total, threshold) from the cores and combines each of the count types read from the cores to produce the aggregate throttle count, the aggregate total count, and the oscillator count, respectively. The counts in the cores may be reset (at block 404). The performance management engine may process (at block 406) the aggregate throttle count and aggregate total count to determine a performance degradation value, such as by dividing the aggregate throttle count by the aggregate total count. This value provides indication of percentage of cycles during which instructions were not executed or throttled.

If (at block 408) the performance degradation value exceeds a high performance degradation threshold, then, in response, the performance degradation value is inputted (at block 410) to a function, such as a look-up table, to determine a voltage increase. If (at block 408) the performance degradation value does not exceed the high threshold, then if (at block 412) the performance degradation value is below a low performance degradation threshold, which may be less than the high performance degradation threshold, then the voltage may be eligible to decrease. In one embodiment, after determining the performance degradation value is below the low performance degradation threshold, a voltage decrease may be indicated, comprising a fixed value. The voltage decrease may be less than the voltage increases. In further embodiments, to avoid oscillation events where a decrease in voltage results in excessive throttling as part of the timing protection control loop, the operations at blocks 414 and/or 416 may be performed to determine whether to delay a voltage decrease to avoid oscillations back to unacceptable performance degradation requiring throttling and possibly a large voltage increase.

If (at block 414) the performance degradation value has been below the low performance degradation threshold for a predetermined number of consecutive determinations, then control may proceed to block 416 for a further test to determine whether to decrease voltage. When DDS output value remains above the throttling value, the throttling counters will not increment and there is not performance loss. There may be additional counts that increment for higher DDS output values. These additional count can be used to prevent large oscillations in the voltage control loop. In one embodiment, an additional oscillation threshold output value counter is used to calculate the percentage of time that the margin is just above the throttling threshold value. If (at block 416) the oscillation threshold output value count satisfies an oscillation threshold condition, then a determination is made (at block 418) of a predetermined fixed voltage decrease. The oscillation threshold condition may be triggered if the oscillator count or percentage of output values in the oscillator count exceeds a predetermined value or percentage. The oscillation threshold condition indicates a low noise workload in which case a small decrease in voltage may result in a large increase in throttling performance loss. In this case no voltage decrease will be requested. In response to block 410 or 418, the performance management engine may indicate (at block 420) the voltage increase or decrease in a command transmitted to the BMC off-chip to have the BMC adjust the voltage by the indicated voltage increase or decrease to forward to the processer power control (PPC). The PPC may then send the adjusted voltage to the POL card to output the adjusted voltage to the processor. From the NO branch of block 412, the NO branch of block 414 or the YES branch of block 416, control ends without adjusting the voltage.

In the embodiment of FIG. 4, both blocks 414 and 416 may be performed to consider delaying a voltage decrease. In alternative embodiments, in response to the YES branch of block 414, control may proceed directly to block 418 without performing the check at block 416. In a further embodiment, from the YES branch of block 412, control may proceed directly to block 416, skipping block 414, and then in response to the NO branch of block 416 to block 418.

The check at block 414 is to ensure that the detected acceptable level of performance degradation is not just transitory and acceptable levels of performance degradation are consecutively detected to indicate the workload is stable and the voltage may be decreased without causing an oscillation back to an unacceptable level of degradation.

The check at block 416 is to determine how many DDS output values are immediately above the throttle output value. For instance, if the oscillation threshold output value counter indicates that number or percentage of output values immediately above the throttle output value exceed some condition, then there is a likelihood that decreasing the voltage will affect performance to cause the DDS output to decrease one output value back to the throttle output value triggering more throttling and possible large voltage increase. However, if the number output values immediately above the throttle output value do not exceed some condition or are not too high, then voltage may be reduced without triggering a large oscillation in voltage and performance loss. Small oscillations may still occur resulting in acceptably small performance loss and power increases.

With the embodiment of FIG. 4, blocks 414 and/or 416 are performed to limit the voltage decrease to situations where the result of the voltage decrease will not likely oscillate back to excessive performance degradation and throttling.

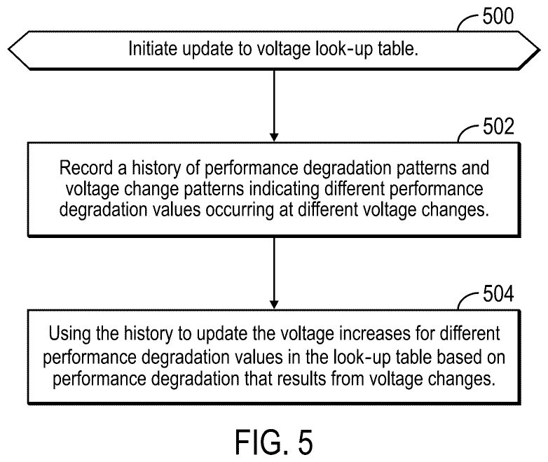

FIG. 5 illustrates an embodiment of operations to update the voltage look-up table based on a recorded history of performance degradation patterns and voltage change patterns to improve the accuracy of the voltage increases specified for different performance degradation values. These operations may be performed by the performance management engine or some other component in the processor or system. For instance, a program may use a machine learning model or a heuristic rules system to determine adjustments to voltage changes specified in the look-up table for performance degradation values. Upon initiating (at block 500) an update to the voltage look-up table, a history is recorded (at block 502) of performance degradation patterns and voltage change patterns. The patterns indicate different performance degradation values that occur at different voltage change levels that were implemented at the processor. This history information may be stored in processor memory or a local memory of the performance management engine. The history information may then be used (at block 504) to update the voltages for different performance degradation values in the look-up table based on performance degradation that results from different voltage changes. The voltage change for a performance degradation value in the look-up table may be adjusted based on the performance degradation value occurring after an applied voltage change indicated in the history. Further, the history is used to modify the function to improve prediction of optimal voltage increases for performance degradation values. Modifying the voltage increases the function outputs for different performance degradation values to enable low-power modes by allowing more performance loss or higher performance modes by reducing performance loss at expense of higher power.

With the embodiment of the operations in FIG. 5, the voltage look-up table is dynamically updated to reflect how current increases in voltage relate to different performance degradation values to optimize the application of the voltage increases in the look-up table. For instance, the program performing the updating may increase a voltage change for a performance degradation value if the history pattern shows application of the current voltage change specified for the performance degradation value did not result in an acceptable level of improvement in a subsequent recorded performance degradation value following the recorded voltage change. Likewise, the program performing the updating may decrease a voltage change for a performance degradation value if the history pattern shows application of the current voltage change specified for the performance degradation value resulted in an overly large improvement in a subsequent recorded performance degradation value following the recorded voltage change.

The present invention may be a computer implemented method, system, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

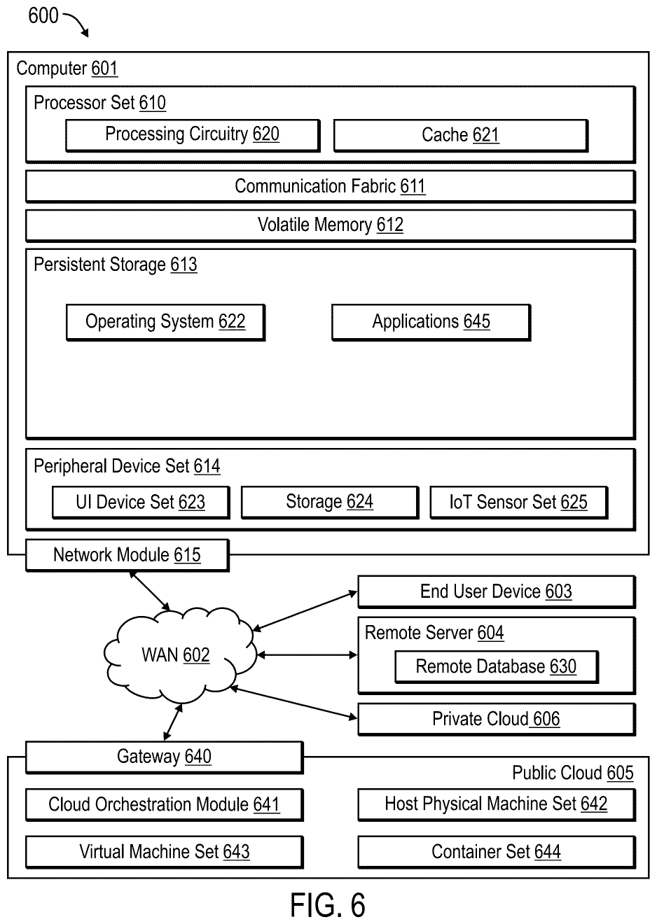

With respect to FIG. 6, computing environment 600 contains an example of an environment for implementing of the processor components involved in performing the inventive methods, such as the interacting timing protection control loop and the voltage control loop as described above. The computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and applications 645), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644. The processor set 610 may comprise the system 100 described above with respect to FIGS. 1 and 2 and the processing circuitry 620 may comprise the components of FIGS. 1 and 2 involved in the timing protection control loop and the voltage control loop of described embodiments.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing. The processor set 610 may comprise the system 100 described above with respect to FIGS. 1 and 2 and the processing circuitry 620 may comprise the components of FIGS. 1 and 2 involved in the timing protection control loop and the voltage control loop of the described embodiments.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 621 and the other storage media discussed below. The program instructions, and associated data, are accessed by processor set 610 to control and direct performance of the inventive methods.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

CLOUD COMPUTING SERVICES AND/OR MICROSERVICES (not separately shown in FIG. 6): private and public clouds 606 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for adjusting voltage at a processing unit, comprising:
calculating a performance degradation value for the processing unit based on instances of a mitigation measure performed when an output value of a sensor satisfies a threshold condition;
inputting the performance degradation value to a function to output a voltage increase, wherein the function provides different voltage increases for different performance degradation values; and
increasing the voltage supplied to the processing unit by the voltage increase.

2. The computer implemented method of claim 1, further comprising:
determining whether the performance degradation value exceeds a degradation threshold value, wherein the inputting the performance degradation value to the function is performed in response to determining that the performance degradation value exceeds the degradation threshold value.

3. The computer implemented method of claim 1, further comprising:
determining whether the performance degradation value exceeds a degradation threshold value; and
decreasing the voltage in response to determining that the performance degradation value is below the degradation threshold value.

4. The computer implemented method of claim 3, wherein the voltage is decreased by a fixed amount.

5. The computer implemented method of claim 3, further comprising:
determining whether the performance degradation value is below the degradation threshold value in a predetermined number of consecutive calculations of the performance degradation value, wherein the voltage is decreased in response to determining that the performance degradation value is below the degradation threshold value the predetermined number of consecutive calculations.

6. The computer implemented method of claim 1, further comprising:
recording a history of performance degradation patterns and voltage change patterns; and
using the history to modify the function to improve prediction of optimal voltage increases for performance degradation values.

7. The computer implemented method of claim 1, further comprising:
determining whether to implement the voltage increase by considering factors selected from the group consisting of a temperature at the processing unit, whether the processing unit is in a maintenance mode, whether a current voltage is within a limit, whether the current voltage increased by the voltage increase is within the limit when the current voltage is not within the limit, whether power is within a limit, and whether the power of other system components are within a limit; and
forwarding a command to a controller to adjust the voltage supplied in response to determining to implement the voltage increase.

8. A computer implemented method for adjusting voltage at a processor having a plurality of cores, comprising:
implementing timing protection control loops for the cores, wherein a timing protection control loop of the timing protection control loops processes an output value from a sensor to determine whether to implement a mitigation measure to throttle instruction execution at a core;
implementing a voltage control loop for a plurality of the cores to perform:
calculating a performance degradation value based on instances output values calculated by timing protection loops at the cores satisfied a threshold condition;
inputting the performance degradation value to a function to output a voltage increase, wherein the function provides different voltage increases for different performance degradation values; and
increasing the voltage supplied to the processor and the cores by the voltage increase.

9. The computer implemented method of claim 8, wherein the timing protection control loops operate more frequently than the voltage control loop.

10. The computer implemented method of claim 8, wherein the threshold condition is satisfied in response to the output value being equal or less than a threshold output value, wherein the output value is based on an operation margin at the processor, further comprising:
incrementing, by the timing protection control loops, a counter in response to output values being equal or less than the threshold output value; and
using, by the voltage control loop, the counter to calculate the performance degradation value, wherein a higher a value of the counter corresponds to a higher performance degradation value.

11. The computer implemented method of claim 10, wherein the operation margin comprises a timing margin to execute an instruction, wherein the mitigation measure comprises increasing number of cycles at a core to execute an instruction, wherein the count indicates a number of cycles during which the cores were not submitting instructions, and wherein the performance degradation value indicates a percentage of cycles not executing instructions.

12. The computer implemented method of claim 8, further comprising:
incrementing, by the timing protection control loops, first counter in response to output values being equal or less than a threshold output value; and
incrementing, by the timing protection control loops, second counter indicating a total number of times the output value was produced, wherein the voltage control loop calculates the performance degradation value comprises dividing a first value of the first counter by a second value of in the second counter.

13. The computer implemented method of claim 8, further comprising:
incrementing, by the timing protection control loops, first counters in response to output values being equal or less than a threshold output value;
incrementing, by the timing protection control loops, second counters in response to output values being one output value above the threshold output value;
determining, by the voltage control loop, whether the performance degradation value exceeds a degradation threshold value;
in response to determining that the performance degradation value is below the degradation threshold value, determining, by the voltage control loop, whether a second counter condition is satisfied based on the second counters, wherein a higher value of the second counters increases a likelihood of the second counters satisfying the second counter condition; and
decreasing, by the voltage control loop, the voltage in response to determining that the second counter condition is not satisfied.

14. The computer implemented method of claim 8, further comprising:
modifying the voltage increases the function outputs for different performance degradation values to enable low-power modes by allowing more performance loss or higher performance modes by reducing performance loss at expense of higher power.

15. A system, comprising:
a processor; and
a plurality of cores in the processor comprising, wherein a core of the cores includes:
a sensor; and
control logic implemented in the cores to perform a mitigation measure when an output value of the sensor satisfies a threshold condition; and
a power management engine to perform:
calculating a performance degradation value for the cores based on instances of the mitigation measure performed when an output value of the sensor satisfies a threshold condition;
inputting the performance degradation value to a function to output a voltage increase, wherein the function provides different voltage increases for different performance degradation values; and
transmitting a command to increase the voltage supplied to the processor by the voltage increase.

16. The system of claim 15, wherein the power management engine further performs:
determining whether the performance degradation value exceeds a degradation threshold value, wherein the inputting the performance degradation value to the function is performed in response to determining that the performance degradation value exceeds the degradation threshold value.

17. The system of claim 15, wherein the power management engine further performs:
determining whether the performance degradation value exceeds a degradation threshold value; and
decreasing the voltage in response to determining that the performance degradation value is below the degradation threshold value.

18. The system of claim 17, wherein the power management engine further performs:
determining whether the performance degradation value is below the degradation threshold value in a predetermined number of consecutive calculations of the performance degradation value, wherein the voltage is decreased in response to determining that the performance degradation value is below the degradation threshold value the predetermined number of consecutive calculations.

19. A system, comprising:
a processor; and
a plurality of cores in the processor comprising timing protection control loops, wherein a timing protection control loop of the timing protection control loops processes an output value from a sensor to determine whether to implement a mitigation measure to throttle instruction execution at a core;
a voltage control loop for a plurality of the cores to perform:
calculating a performance degradation value based on instances output values calculated by timing protection loops at the cores satisfied a threshold condition;
inputting the performance degradation value to a function to output a voltage increase, wherein the function provides different voltage increases for different performance degradation values; and
increasing the voltage supplied to the processor and the cores by the voltage increase.

20. The system of claim 19, wherein the threshold condition is satisfied in response to the output value being equal or less than a threshold output value, wherein the output value is based on an operation margin at the processor,
wherein the timing protection control loops increment a counter in response to output values being equal or less than the threshold output value, and
wherein the voltage control loop uses the counter to calculate the performance degradation value, wherein a higher a value of the counter corresponds to a higher performance degradation value.

21. The system of claim 19, wherein the timing protection control loops further perform:
incrementing first counters in response to output values being equal or less than a threshold output value;
incrementing second counters in response to output values being one output value above the threshold output value;
wherein the voltage control loop further performs:
determining the performance degradation value exceeds a degradation threshold value;
in response to determining that the performance degradation value is below the degradation threshold value, determining whether a second counter condition is satisfied based on the second counters, wherein a higher value of the second counters increases a likelihood of the second counters satisfying the second counter condition; and
decreasing the voltage in response to determining that the second counter condition is not satisfied.

22. A processor, comprising:
a plurality of cores, wherein a core of the cores includes:
a sensor; and
control logic implemented in the cores to perform a mitigation measure when an output value of the sensor satisfies a threshold condition; and
a power management engine to perform:
calculating a performance degradation value for the cores based on instances of the mitigation measure performed when an output value of the sensor satisfies a threshold condition;
inputting the performance degradation value to a function to output a voltage increase, wherein the function provides different voltage increases for different performance degradation values; and
transmitting a command to increase the voltage supplied to the processor by the voltage increase.

23. The processor of claim 22, wherein the power management engine further performs:
determining whether the performance degradation value exceeds a degradation threshold value, wherein the inputting the performance degradation value to the function is performed in response to determining that the performance degradation value exceeds the degradation threshold value.

24. The processor of claim 22, wherein the power management engine further performs:
determining whether the performance degradation value exceeds a degradation threshold value; and
decreasing the voltage in response to determining that the performance degradation value is below the degradation threshold value.

25. The processor of claim 24, wherein the power management engine further performs:
determining whether the performance degradation value is below the degradation threshold value in a predetermined number of consecutive calculations of the performance degradation value, wherein the voltage is decreased in response to determining that the performance degradation value is below the degradation threshold value the predetermined number of consecutive calculations.
